(19) United States
(12) Patent Application Publication
(10) Pub. No.: US 2013/0246280 A1
(43) Pub. Date: Sep. 19, 2013

(54) SECURE DIGITAL INVOICE PROCESSING

(71) Applicant: OneID, Inc., Redwood City, CA (US)

(72) Inventor: STEVEN TODD KIRSCH, LOS ALTOS HILLS, CA (US)

(73) Assignee: ONEID, INC., Redwood City, CA (US)

(21) Appl. No.: 13/796,870

(22) Filed: Mar. 12, 2013

Related U.S. Application Data
(60) Provisional application No. 61/609,848, filed on Mar. 12, 2012.
(60) Provisional application No. 61/609,739, filed on Mar. 12, 2012.

(51) Int. Cl. G06Q 20/14

(52) U.S. Cl. CPC G06Q 20/14
USPC 705/71; 705/40

(57) ABSTRACT

A method of processing a digital invoice may include receiving, at the access device, a digital invoice for the transaction; sending, from the access device to an identity repository, information associated with the digital invoice; receiving, from the identity repository, a first signature for the digital invoice; providing, by the access device, a second signature for the digital invoice; and sending, from the access device, the first signature and the second signature for use in the transaction.

### CROSS-REFERENCES TO RELATED APPLICATIONS

This application claims priority to the following two U.S. Provisional patent applications, and the entire disclosure of each of these applications are incorporated by reference into this application for all purposes:
U.S. Provisional Patent Application No. 61/609,848, filed Mar. 12, 2012 entitled “Methods and Systems for Secure Identity Management” (Attorney Docket No. 94276-833770(000400US)); and
U.S. Provisional Patent Application No. 61/609,739, filed Mar. 12, 2012 entitled “Method and System for Buyer-Centric Purchasing Process” (Attorney Docket No. 94276-833851(000600US)).

The following two regular U.S. patent applications (including this one) are being filed concurrently, and the entire disclosure of the other applications are incorporated by reference into this application for all purposes:
U.S. patent application Ser. No. ______, filed Mar. 12, 2013, entitled “Secure Mobile Transactions” (Attorney Docket No. 94276-868032(000310US)); and
U.S. patent application Ser. No. ______, filed Mar. 12, 2013, entitled “Secure Digital Invoice Processing” (Attorney Docket No. 94276-868033(000610US)).

### BACKGROUND

Personal computing devices have become an important part of the retail landscape. Smart phones, tablet computers, laptops, and personal computers are being used by large segments of the population to engage in retail, banking, and communication transactions. By necessity, these transactions require identity verification and communication security in order to avoid compromising sensitive data. Therefore, sensitive data has to either be remembered by a user or stored somewhere on a computing device. Sensitive data is often lengthy and complicated, and thus, it is unwieldy for users to be expected to remember and enter this information reliably.

Just as personal computing devices have recently gained popularity for engaging in secure transactions, attackers and malware creators have seized on this fertile new ground for criminal purposes. Users often have viruses and other types of malware operating on their user devices without their knowledge. These malicious software processes can often compromise the widespread use of computerized transactions to gain access to personal information. This personal information can be transmitted to distant locations and exploited long before users know their data has been compromised.

In contrast, most retail transactions still take place in a face-to-face manner between a purchaser and a merchant. Generally, purchasing terms are agreed upon verbally or are decided as an inherent part of the transaction. For example, a purchaser might bring a product to a point of sale, where a representative of the merchant may ask for certain purchasing options, such as a credit card number. The terms of the transaction are often left out in the open and are vulnerable to miscommunication errors and eavesdroppers. Therefore, improvements are needed in the art.

### BRIEF SUMMARY

The present invention relates generally to online, or virtual identities. More specifically, the present invention relates to methods and systems for using virtual identities to securely process digital invoices. Merely by way of example, the invention has been applied to a method of securely transferring digital invoices and authorizing signatures between an access device of a purchaser and a relying party device of a merchant to be processed by, for example, a bank. The methods and techniques can be applied to a variety of transactions, interactions, and identity management systems.

In one embodiment, a method of processing a digital invoice using an access device for a transaction between the access device and a merchant device may include receiving, at the access device, a digital invoice for the transaction. The method may further include sending, from the access device to an identity repository, information associated with the digital invoice. The method may also include receiving, from the identity repository, a first signature for the digital invoice. The method may additionally include providing, by the access device, a second signature for the digital invoice. The method may further include sending, from the access device, the first signature and the second signature for use in the transaction.

In some embodiments, the digital invoice may comprise a transaction price. The first signature may be associated with a particular payment method. The first signature and the second signature may be associated with a particular bank or credit card company. The first signature and the second signature may be associated with corresponding cryptographic keys stored at a payment processing device. The first signature may be generated using a private key, and a public key corresponding to the private key may be stored by a payment processing device. The first and second signatures may be configured to be verified by a payment processing device such that the payment processing device can provide a credit card number.

In some embodiments, the method may also include receiving, from the identity repository, a third signature for the digital invoice, where the third signature may be provided by a control device. The method may further include sending, from the access device to the identity repository, the third signature for use in the transaction. The method may further include providing, by the access device, an output comprising a request for a passcode to verify an identity of a user; receiving, by the access device, an input comprising the passcode; and sending, from the access device to the identity repository, the information associated with the passcode for the identity repository to verify the identity of the user.

In some embodiments, the method may also include providing, by the access device, a first identifier that identifies a payment provider. The method may also include providing, by the access device, a second identifier that identifies an account at the payment provider. The method may further include sending, from the access device, the first identifier and the second identifier with the first signature and the second signature. The first digital signature and the second digital signature may be generated using private keys. The private keys may be associated with public keys at the payment provider. The public keys may be associated with the account or a user of the access device at the payment provider.

In another embodiment, a method of processing a digital invoice for a transaction between an access device and a merchant device by an identity repository may include receiving, at the identity repository from the access device, information associated with a digital invoice for the transaction. The method may also include associating the access device with a virtual identity. The method may additionally include determining that the access device is authorized to participate in the transaction. The method may further include providing, by the identity repository, a first signature for the digital invoice. The method may also include sending, from the identity repository to the access device, the first signature.

In yet another embodiment, an identity repository for providing secure information for a transaction between an access device and a relying party device, may include one or more processors and a memory communicatively coupled with and readable by the one or more processors and comprising a sequence of instructions. The instructions, when executed by the one or more processors, may cause the one or more processors to facilitate the transaction by receiving, at the identity repository, information associated with a digital invoice for the transaction. The instructions may also cause the processor(s) to associate the access device with a virtual identity. The instructions may additionally cause the processor(s) to determine that the access device is authorized to participate in the transaction. The instructions may further cause the processor(s) to provide, by the identity repository, a first signature for the digital invoice. The instructions may also cause the processor(s) to send, from the identity repository to the access device, the first signature, wherein the access device provides a second signature for the digital invoice.

Numerous benefits can be achieved by way of the present invention over conventional techniques. For example, embodiments of the present invention reduce the likelihood that malicious actors can intercept form data during a transaction. Additionally, embodiments of the present invention provide a system for reducing errors and inconveniences that may be introduced during verbal or written communication of transaction and purchasing information. These and other embodiments along with many of their advantages and features are described in more detail in conjunction with the text below and attached figures.

### BRIEF DESCRIPTION OF THE DRAWINGS

A further understanding of the nature and advantages of the present invention may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a simplified block diagram of an exemplary identity management system, according to one embodiment.

FIG. 2 illustrates a simplified block diagram of key storage for an identity management system, according to one embodiment.

FIG. 3 illustrates a simplified diagram of various payment methods, according to one embodiment.

FIG. 4 illustrates a simplified block diagram of key storage for an invoice processing system, according to one embodiment.

FIG. 5A illustrates a simplified block diagram of devices that may be used to process digital invoices, according to one embodiment.

FIG. 5B illustrates a simplified block diagram of additional devices that may be used to process digital invoices, according to one embodiment.

FIG. 6 illustrates a simplified swim diagram of signatures for a digital invoice, according to one embodiment.

FIG. 7A illustrates a simplified swim diagram of processing a signed digital invoice, according to one embodiment.

FIG. 7B illustrates a simplified swim diagram of processing a signed digital invoice using a translation gateway, according to one embodiment.

FIG. 8A illustrates a simplified flowchart of a method of securely processing a digital invoice using an access device, according to one embodiment.

FIG. 8B illustrates a simplified flowchart of a method of securely processing a digital invoice using an identity repository, according to one embodiment.

FIG. 9 illustrates a block diagram of components for an exemplary operating environment in which various embodiments of the present invention may be implemented.

FIG. 10 illustrates a block diagram of an exemplary computer system in which embodiments of the present invention may be implemented.

### DETAILED DESCRIPTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Described herein, are embodiments for securely processing digital voices that are associated with a transaction. The invoice may be used to complete a purchase, to select an item, to select a purchasing method, to verify the identity of a purchaser or a merchant, to register an account, to make a donation, to leave a tip, to add notes or commentary to a purchase record, and/or the like. Prior to this disclosure, invoice information was commonly passed between the user and the merchant using verbal, written, or symbolic communication. For example, when purchasing a dinner at a restaurant, a user could provide a credit card number printed on a credit card medium by hand to the merchant, verbally asked the merchant to use the credit card to settle the transaction, provide a written signature to authorize the transaction, write a tip amount on the transaction receipt, and manually record the transaction in an expense book.

The manual transaction described above may be fraught with potential errors. During verbal communication, numbers or authorizations may be misheard by one of the parties. Handwriting may be difficult to decipher, particularly numbers used to describe payment. Errors in passing information between the user and the merchant may result in incorrect billing, processing delays, and general frustration on the part of both parties. Signatures may be forged.

More importantly, the information exchange described above is not secure. Credit card numbers are exchanged in the open, often with a magnetic strip that can be read by devices at almost every point of sale. Credit card numbers can be lifted, signatures can be copied, and purchasing authorizations can be reused to make fraudulent transactions. Additionally, when exchanging personal information, such as a name, address, phone number, or date of birth, the user may be exposed to identity theft. The information exchanged in the clear may be used to open fraudulent bank accounts, initiate loans, purchase property, and engage in transactions, along with many other activities with the potential to damage the financial and social reputation of the user.

Another problem associated with manual transactions relates to the sheer volume of information that consumers may be expected to remember. In order to complete a transaction, merchants may request personal information such as identification, names, addresses, shipping addresses, billing addresses, credit card information, credit card numbers, credit card verification (CCV) numbers, organizations, titles, Social Security numbers, birth dates, transaction amounts, bank account numbers, routing numbers, personal identification numbers (PINs), passwords, usernames, e-mail addresses, telephone numbers, hardware identification (ID) numbers, and/or the like. The embodiments discussed herein may be used to exchange any type of information in addition to the information listed above.

Instead of remembering sensitive information, consumers may keep written records in a purse or wallet that can be stolen, lost, or destroyed. Instead of writing down their sensitive information, other consumers may make the more serious mistake of storing their sensitive information on their mobile computing devices. It has been discovered that malware and other types of viruses may easily be configured to search for sensitive information on a computing device. Password files may be compromised and transmitted to an attacker resulting in fraudulent use of a consumer's banking information.

Users may also be vulnerable to an over-the-shoulder eavesdropping attack if they fail to properly shield their written and/or verbal communications from nearby onlookers. Consumers may also enter purposely or accidentally provide incorrect information. On the merchant side, incorrectly entered information may result in erroneous orders, shipments to the wrong location, incorrect contact information, and other problems.

Even if consumers could safely remember their sensitive information without writing it down and securely communicate this information to a merchant outside of the earshot of any eavesdropper, this process may represent an inconvenience. Depending on the amount of information that needs to be exchanged, this inconvenience may deter consumers from making purchases. The prospect of providing contact information, business information, shipping addresses, billing addresses, usernames, passwords, credit card information, and/or the like, every time a consumer wants to make a purchase may simply be overwhelming or inconvenient for many consumers. Each transaction may represent a constant reminder to the consumer that they are giving away personal information that may be used for fraudulent purposes.

Additionally, typical credit card transactions require sharing secrets. Typically, a user must pass all information needed to charge a credit card account to the merchant. The merchant then has the opportunity to distribute this information to other parties, or to apply additional charges to the credit card account that were not authorized by the user. While the user may later dispute these fraudulent charges, this represents at minimum a massive inconvenience, and for consumers who are not vigilant about checking their credit card statements, this represents outright theft.

The embodiments described herein may be used to solve these and many other problems related to processing digital invoices in association with transactions between parties. In some embodiments, a secure repository, also referred to as an identity repository, may be used to provide signatures for digital invoices and to enforce levels of assurance (LoA's) required by various parties to the transaction. The identity repository may be remotely located geographically away from users at a secure location. The sensitive information at the identity repository may be encrypted, and the cryptographic keys needed to access the sensitive information may be stored at a separate physical location, such as on a user device. When providing transactional information, the identity repository may provide the information to the merchant, supplemented by information provided by the user.

In some embodiments, a digital invoice may be sent to an access device of a user making a purchase. The digital invoice may be sent from a merchant device. The user may be prompted to approve the transaction represented by the invoice and to choose a method of settling the transaction, such as selecting a credit card account. The access device may then provide a signature for the digital invoice. The signature may be used to extract a payment method for the digital invoice such that the payment method need not be shared with the merchant.

In some embodiments, the access device may also request that a signature be provided by the identity repository. The signature of the identity repository may be used to verify the identity of the user making the purchase. The signature of the identity repository may also be used to determine a payment method for the digital invoice. For example, if a user selects a credit card account to settle the invoice, the signature provided by the access device and/or the identity repository may be used to encode the credit card number. Many variations and different embodiments are described further herein.

The merchant may receive the signature(s) from the access device, and may pass the signatures and possibly the digital invoice to a payment processing device, such as a bank or payment gateway. The payment processing device may then use the signatures to the verify the identity of the user and the authenticity of the transaction. In some cases, the payment processing device may also use the signatures to determine and/or decrypt a payment method and/or a charge amount. Many variations and different embodiments are described further herein.

This disclosure is divided into three sections. First a basic overview of a secure identity management system will be provided. This secure identity management system can be used to provide signatures that can be verified by a payment processing system. Next, exemplary embodiments for securely processing digital invoices for the transactions will be presented. These embodiments will illustrate how to utilize the identity repository to securely provide payment information and identity verification to a payment processing device. Finally, an exemplary hardware system will be provided comprising network computing devices that can be used to implement the various embodiments disclosed herein.

### Secure Identity Management

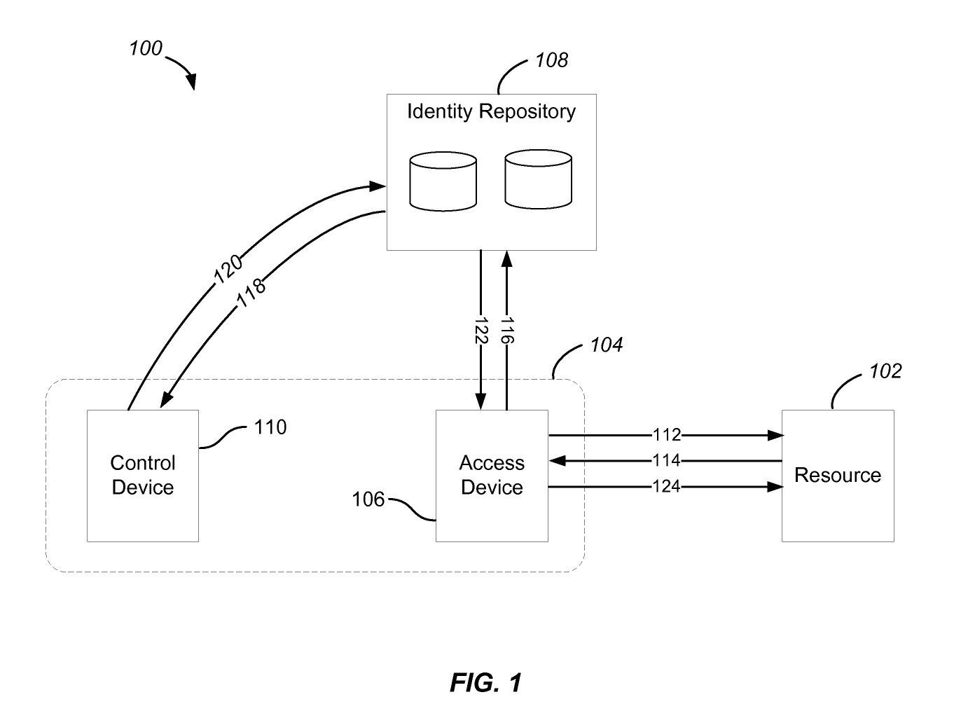

FIG. 1 illustrates a simplified block diagram 100 of a system for online identity management, according to an embodiment of the present invention. The system may be configured to use one or two user devices. At its most basic level, the system can use an access device 106. The access device 106 will typically be the device the user is using for an interaction. Second, an optional control device 110 may be used. The control device 110 may comprise a personal device, such as a smart phone, tablet computer, personal computer, and/or personal digital assistant (PDA) that is controlled by the user. Additionally, a remotely located identity repository 108 can be used in the interaction. The access device 106 can engage in the interaction with a resource 102. The resource can include a website, a database, a web service, and/or the like. Man-in-the-middle attacks can be reduced because cryptographic secrets can be transferred from user controlled endpoint devices securely, even if the identity repository is compromised by an attacker.

In this embodiment, the access device 106 (AD) may comprise a user device that is being authenticated to perform a transaction using a virtual identity. The control device 110 (CD) may comprise a second user device in the user's control that is used to set access rights for the users access device 106 and to perform OOB authentication/verification. The resource 102 (RP) may be defined as a party, typically a website, to which the user wishes the virtual identity to be authenticated and, optionally, with which to share attributes and perform additional transactions. The identity repository 108 (Repo) may be defined as an online database of encrypted credentials and attribute/value pairs. The identity repository 108 may be remotely located and may be operated by a third party that is not associated with either the user or the resource 102. Each access device 106 and control device 110 may have a unique identifier, referred to as a Device ID (DEVID). Additionally, each user may have a unique identifier, or Global User ID (GUID), that is stored on the access device 106 and on the control device 110 and can be used to index information stored on the identity repository 108. Finally, each user may have a second user identification (UID) that comprises a site-specific identifier for the user for the resource 102. The UID can be derived at least in part from the fully-qualified domain name associated with the resource 102.

In one embodiment, the access device 106 and the identity repository 108 can be required in order to complete a transaction. The control device 110 can be a separate device from the access device 106, or the same physical device can be used as both the access device 106 and the control device 110. For example, a laptop can function as both the access device 106 and the control device 110. A mobile phone could also function as both devices. Participation by the control device 110 may optionally be required in a transaction to provide a higher level of assurance that the user has consented to the transaction. This process will be described further below. At any time, the user may choose to use a higher security mode comprising a higher level of assurance. The user can also choose to lock out any individual device or force the individual device into a higher security mode. These actions can be performed on any device registered by the user. Furthermore, some embodiments may employ a special “tripwire” feature so that, if a password or PIN is not entered when requested, a device will be prevented from supplying any subsequent digital signatures until the requested password or PIN is provided.

As used herein, transactions may use a varying “Level of Assurance” (LoA) mode. In one embodiment, four modes are supported: disabled, enabled with no security, password with a timeout, and out-of-band (OOB) authorization required with an optional PIN and timeout. Users can control the LoA mode required by each type of transaction. To minimize risk in the case of a lost user device, devices can be immediately turned off from any remaining registered device that the user still controls. In one embodiment, the identity repository 108 can enforce the greater of two LoA modes: the level requested by the user and the level requested by the resource 102. This can ensure that organizations, such as financial institutions, can be compliant with regulations regardless of the security level requested by the user. For example, a bank could require that, for transaction to be approved, a PIN should be entered on the control device 110 within a time period, such as 5 minutes. For banks, two factor authentication may be required by FFIEC regulations.

According to one embodiment, the conditions in an LoA mode may be based on information related to the devices owned or operated on behalf of the user or devices authorized for the user with limits on how devices can be used in the transaction. For example, a desktop computer in a secure work area may have a higher transaction value limit than a mobile device. A mobile device with a password-to-unlock feature may have a higher transaction value limit than an unlocked mobile device. One of ordinary skill in the art would recognize many variations, modifications, and alternatives.

The conditions in an LoA mode can include information related to preferences established by one of the parties, including transaction value limits, time periods during which transactions are initiated, geographic locations where the transaction is initiated, histories of returns or invalidated transactions, user reputations, number of transactions within a particular time period, or the like. The conditions in an LoA mode can also include cumulative data, including thresholds for the number of items in a single purchase, cumulative costs of items in a single transaction, cumulative amount spent in a particular time period, and/or the like. Therefore, the conditions in an LoA mode can comprise a cost threshold for a single transaction, a cumulative cost threshold for transactions during a time period, or a time limit since a password was provided to a user device. These conditions can be used to define almost every aspect of a transaction/interaction, such that a party can set specified authentication levels that add security to high-value transactions or transactions where the risk of fraud is high. It should be noted that if preferences received from a party contradict preferences already stored on the device executing this method, the more conservative or secure preferences can be used in the transaction.

According to one embodiment, the conditions in an LoA mode may also include conditions related to types of transactions. For example, purchasing certain types of goods, such as jewelry, cars, software, collectibles, or the like, that are more likely to be involved in theft and fraud can require higher levels of authentication. The conditions can also include conditions on payment options. For example, purchasing items with a credit card may require a first authorization level, while paying for items with a debit card may require a second authorization level. The preferences can also include conditions on methods of shipping or shipping locations. For example, shipping items to a Post Office Box or to an address different from the billing address may require a higher authorization level.

Each of the conditions of an LoA mode may be associated with one or more authentication levels. If the condition is met, then the specified authentication level (or a higher authentication level) should be used in the transaction/interaction. An authentication level can comprise requiring an indication that the transaction is approved to be received by a user module operating on a user device. For example, a user may be required to provide input indicating that they have reviewed the transaction and approve. An authentication level can also comprise notifying additional devices that are associated with the user. For example, a notification can be sent to a user's cell phone or tablet computer for a transaction that was initiated on the user's desktop computer. An authentication level can comprise requiring a PIN or password to be received by one or more of the additional devices associated with the user, such as a control device. An authentication level can comprise a waiting period between initiating the transaction and final approval. In one embodiment, an authentication level may require human contact by a representative of the relying party. In another embodiment, an authorization level can require a third-party to authenticate the transaction, such as the identity repository.

In one embodiment, an LoA mode can also specify a timeout period associated with each PIN and/or password. For example, one mode could specify that a password should be entered into the access device within the last three hours preceding the transaction/interaction.

As another example, one mode could specify that a PIN should be entered into the control device within five minutes preceding the transaction interaction. The timeout period may be affected by other factors, such as the time of day of the transaction, a cost associated with the transaction, the security of the device used in the transaction, a cumulative cost of a set of transactions, and/or any other factors described above. For example, a timeout period may be longer on a secure device, whereas the timeout period may be shorter on an insecure device.

What follows is a brief description of one exemplary transaction. Each step in this exemplary transaction will be discussed in more detail later in this disclosure. Returning to block diagram 100 of FIG. 1, the access device 106 can access the resource 102 (112). In response, the resource 102 can return a random digital challenge and request that the access device 106 return the challenge signed by two or three signatures (114). Next, the access device 106 can generate one or more cloud repository keys. The access device 106 can pass the digital challenge and the one or more cloud repository keys to the identity repository 108 (116). If the access device 106 is password protected and a timeout period is exceeded, the user may supply digital proof that the user knows the password to the access device 106. The digital proof may comprise a guess of the password. In one embodiment, the digital proof is not transmitted off of the access device 106, not even in a hashed or encrypted form. Confirmation that the user knows the password is provided by signing a challenge from the identity repository 108.

The identity repository 108 can compare a first LoA mode specified by the access device 106 with a second LoA mode specified by the resource 102 to determine whether an OOB approval should also be required for the transaction. If an OOB approval is determined to be required by either the access device 106 or the resource 102, the identity repository 108 sends a challenge to the control device 110 (118). In one embodiment, certain details of the original transaction can be displayed to the user on the control device 110, thus eliminating the possibility of a man-in-the-browser attack or a man-in-the-middle attack. A PIN can also be requested by the control device 110. If a PIN has not been provided within a timeout period, the control device 110 may prompt the user to enter the PIN. In one embodiment, any PIN guess entered by the user never leaves the control device 110. Instead, the control device 110 can rely on asymmetric cryptography and another challenge from the identity repository 108 to prove to the identity repository 108 that the user has supplied the correct PIN. This process will be described further later in this disclosure. Approval for the transaction, along with any signed challenges, can be sent back to the identity repository 108 (120). In one embodiment, the control device 110 signs the challenge from the resource 102 using a private key stored on the control device 110.

The identity repository 108 can enforce the LoA mode on the transaction. Therefore, the identity repository 108 can withhold its signature on the challenge unless all of the requirements of the LoA mode have been met. If the identity repository 108 determines that all of these requirements have been met, the identity repository 108 can sign the challenge using its private key. The identity repository 108 can then send the signature of the control device 110 and the signature of the identity repository 108 to the access device 106 (122). At this point, the access device 106 can sign the challenge and return all two/three signatures to the resource 102 (124). Additionally, the access device 106 can send a user ID (the site-specific user ID). The resource 102 can look up a set of public keys that are associated with the UID to verify that all three signatures correspond to the public keys and grant access to the user. In one embodiment, the public keys can be unique to the resource 102. In other words, each website will be associated with its own set of public and private key pairs. This can assure a user's privacy and prevent website tracking Because the resource 102 interacts with the access device 106, the identity repository 108 can be prevented from determining which resources the user has visited. The identity repository 108 simply holds an encrypted block of data and receives commands to read and write encrypted keys and values.

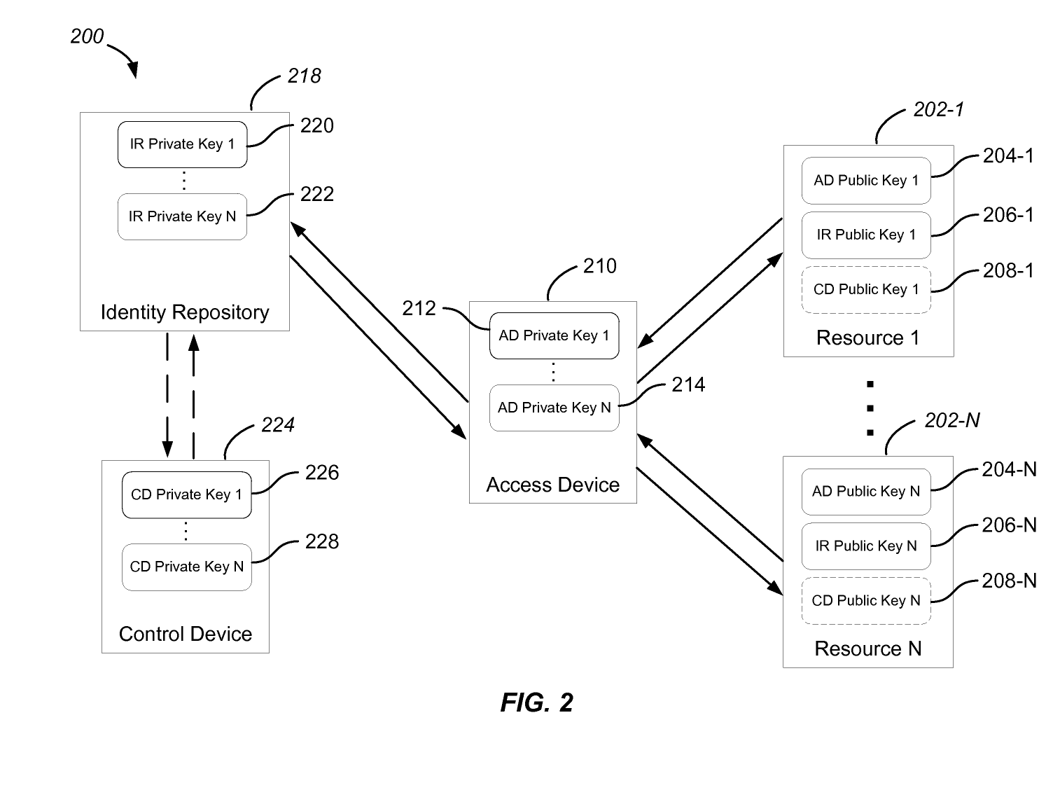

FIG. 2 illustrates a simplified block diagram 200 of a system for online identity management with distributed secrets, according to an embodiment of the present invention. The embodiment of FIG. 2 uses a subset of the keys that may be used by various embodiments of the identity management system. Note that the remaining keys may be operative in the background of the system illustrated by FIG. 2. Additionally, the keys in FIG. 2 may be derived from one or more of the keys not explicitly shown in FIG. 2. As described earlier, an access device 210 may engage in a transaction with a number of resources 202. Each of the resources 202 may have a set of public keys associated with a UID of a user of the access device 210. For example, resource 202-1 stores two to three public keys for the UID 210, namely an AD public key 204-1 that is associated with the access device 210, an IR public key 206-1 that is associated with an identity repository 218, and, optionally, a CD public key 208-1 that is associated with a control device 224.

When the access device 210 first attempts a transaction with one of the resources 202, the access device 210 can provide the public keys 204, 206, 208 to the resources 202. Each of the resources 202 may have a unique set of public keys. In providing the public keys 204, 206, 200, the access device 210 may create the AD public keys 204, and the IR public keys 206 and the CD public keys 208 can be obtained from the identity repository 218 and the control device 224, respectively.

When initiating a transaction, the resources 202 can send a digital challenge to the access device 210 to authenticate a virtual identity. When the LoA mode requirements of each device of been met, each device may sign the digital challenge using the private keys that correspond to the public key of the particular resource. For example, a digital challenge sent from resource 202-1 could be signed by the access device 210 using AD private key 212 and the identity repository 218 using the IR private key 220. Optionally, the digital challenge could also be signed by the control device 224 using the CD private key 226. Each of these devices may enforce one or more requirements of the LoA mode before signing. For example, the control device 224 may require a PIN from the user, and the identity repository 218 may require an OOB authorization from the control device 224. The access device 210 may require a signature from the identity repository 218 as well as a signature from the control device 224 before signing the digital challenge. Other embodiments may enforce different requirements as described elsewhere herein.

In one embodiment, each of these keys are actually stored on their respective devices. In another embodiment, a master key is stored and each device from which the keys in FIG. 2 are deterministically derived when they are needed. For example, the AD private key 212 may be derived from an Access Device Key (ADK) for the access device 210.

### Secure Mobile Transactions

The “transactions” referred to in the above discussion should be interpreted broadly. In some cases, a transaction may involve a commercial purchase. In other cases, a transaction may simply involve retrieving securely stored information from the identity repository and decrypting the information for use by a merchant. In other cases, a transaction may include registering for an event, membership, service, or lottery. The transaction may also include verifying the identity of a user to a merchant. Transactions may be in-person, over-the-phone, or via other means of communication such as e-mail, text message, voice mail, physical letters, and/or the like.

Traditionally, many transactions were settled when a purchaser, or user, gave a merchant a credit card from which a credit card account number could be retrieved. The merchant would gain authorization to charge the credit card account for a certain amount in exchange for the purchase. In order to authorize the charge the amount, the purchaser would physically sign a paper receipt, or more recently, sign an input device using a pen, stylus, or similar device. In these cases, the receipt requesting payment may be referred to as an invoice.

As used herein, the terms “invoice” or “digital invoice” may be interpreted broadly to include any representation of a transaction. For example, a digital invoice may be sent from a merchant to a user device describing a purchase, a purchase amount, a product type, a product quantity, and/or the like. A digital invoice may include an indication that the merchant is requesting payment to settle a transaction. A digital invoice may include representations of the transaction stored in any format. For example, a digital invoice may be stored as a file, may include a scanned version of a paper receipt, may be stored in the body or attachment of an e-mail, and/or the like.

Some digital invoices may request information from a user. For example, a digital invoice may request a selection of a payment method, a tip amount, product options, purchasing options, a shipping address, and/or the like. Some digital invoices may request a cryptographic signature to authorize the transaction.

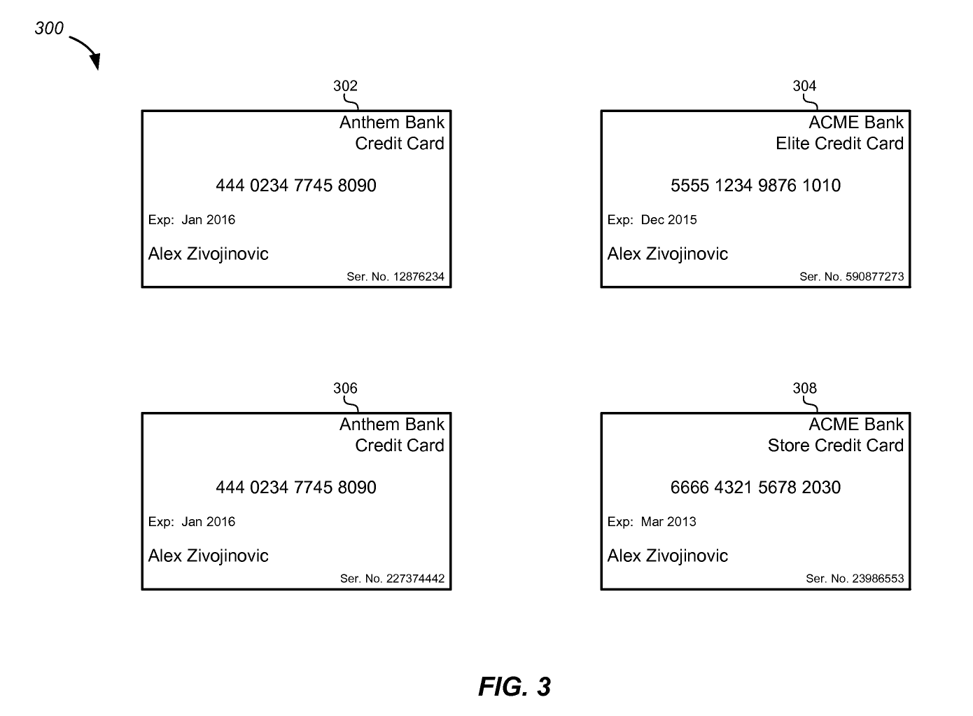

FIG. 3 illustrates a simplified diagram 300 of various payment methods, according to one embodiment. The payment methods illustrated by diagram 300 represent credit card payment methods. Credit cards are merely exemplary, and other payment method may include bank account numbers, debit card accounts, lines of credit, and/or the like.

Diagram 300 shows that many different types of payment methods may be associated with a single individual. In this case, a user, Alex Zivojinovic may have four different types of credit cards. Credit card 302 and credit card 306 may be issued by first credit card company or bank (“Anthem Bank”), while credit card 304 and credit card 308 may be issued from a second credit card company or bank (“ACME Bank”).

Note that credit card 302 is the same as credit card 306, with each having the same credit card account number. Only the serial number differs between credit card 302 and credit card 306. Credit card companies may issue multiple copies of the same card, each having a different serial number. For example, a husband and wife may each have a credit card with the same account number printed thereon, with each card having a different serial number. Credit card 304 and credit card 308 are issued from the same bank to the same user, yet each card has a different account number. Some credit card companies may issue multiple types of credit cards. For example, a credit card company may offer an elite credit card and a regular credit card to the same individual, as different cards may offer different reward types or benefits depending on the transaction type. Also, users may have credit cards from the same bank that are specifically associated with different retailers or stores.

FIG. 3 illustrates that users may have multiple payment options provided by multiple banking or credit card entities. When providing a signature for a transaction, signatures may be associated with particular payment types. In some embodiments, signatures may be generated using cryptographic keys. Different cryptographic keys may be associated with different payment types. For example, one cryptographic key could be specifically associated with Anthem Bank and could therefore be used to sign transactions where credit card 302 or credit card 306 is the preferred payment method. Anthem Bank could then accept a transaction using credit card 302 and/or credit card 306 so long as the cryptographic key associated with Anthem Bank was used to sign the transaction.

In addition to entity-specific signatures, some embodiments may also use account-specific signatures. For example, ACME Bank could accept a first signature type for credit card 304, as well as a second signature type for credit card 308. Similarly, in some embodiments, signature types may be also specific to a user. For example, a user may use a single cryptographic key to sign all transactions that would be accepted by both Anthem Bank as well as ACME Bank, and could be accepted for transactions using credit cards 302, 304, 306, and/or 308.

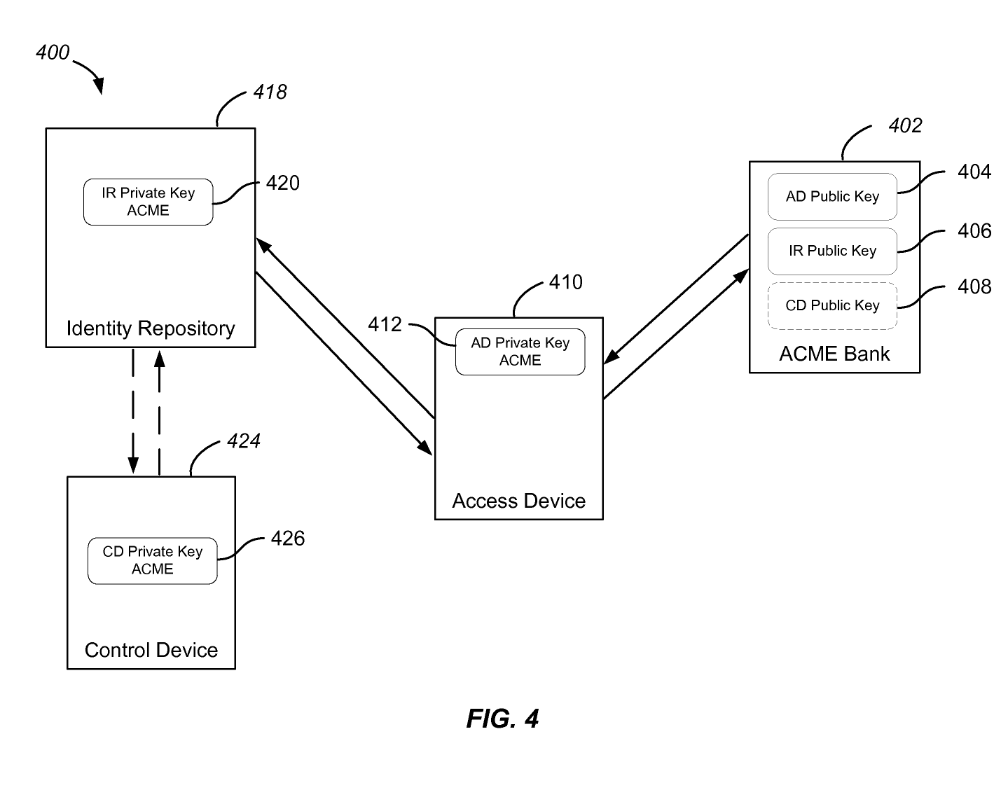

FIG. 4 illustrates a simplified block diagram 400 of key storage for an invoice processing system, according to one embodiment. As described in the sections above, an access device 410, an identity repository 418, and/or a control device 424 may each store private keys. The associated public keys may be stored by a relying party device 402, such as a device belonging to or operated by ACME Bank.

In this particular embodiment, each device 410, 418, and/or 424 may have its own private key associated with the particular signature type. For example, the access device 410 may have an access device private key 412 associated with ACME Bank. Similarly, the identity repository 418 may store an identity repository private key 420 in the user account that is associated with ACME Bank. Similarly, the control device 424 may store a control device private key 426 that is associated with ACME Bank. On the other side of the transaction, the relying party device 402 may store public keys 404, 406, and/or 408 that correspond to the private keys stored on the user devices and at the identity repository.

In this embodiment, only a single signature type is illustrated for the public and private keys. This signature may correspond to a bank or credit card specific signature type. For example, a user may have many different payment options (credit card accounts, debit accounts, direct deposit accounts, etc.) associated with ACME Bank. Any of these payment methods could be used in conjunction with the signature provided by the ACME Bank private keys 410, 420, and/or 426.

In other embodiments not shown explicitly, the access device 410, the identity repository 418, and/or the control device 424 may each have stored thereon many different private keys that may generate many different signatures. For example, private keys may be used to generate signatures that correspond to each payment method associated with ACME Bank. Private keys may be used to generate signatures that correspond to different types of transactions, different merchants, different geographic locations, different times, different levels of assurance, and so forth.

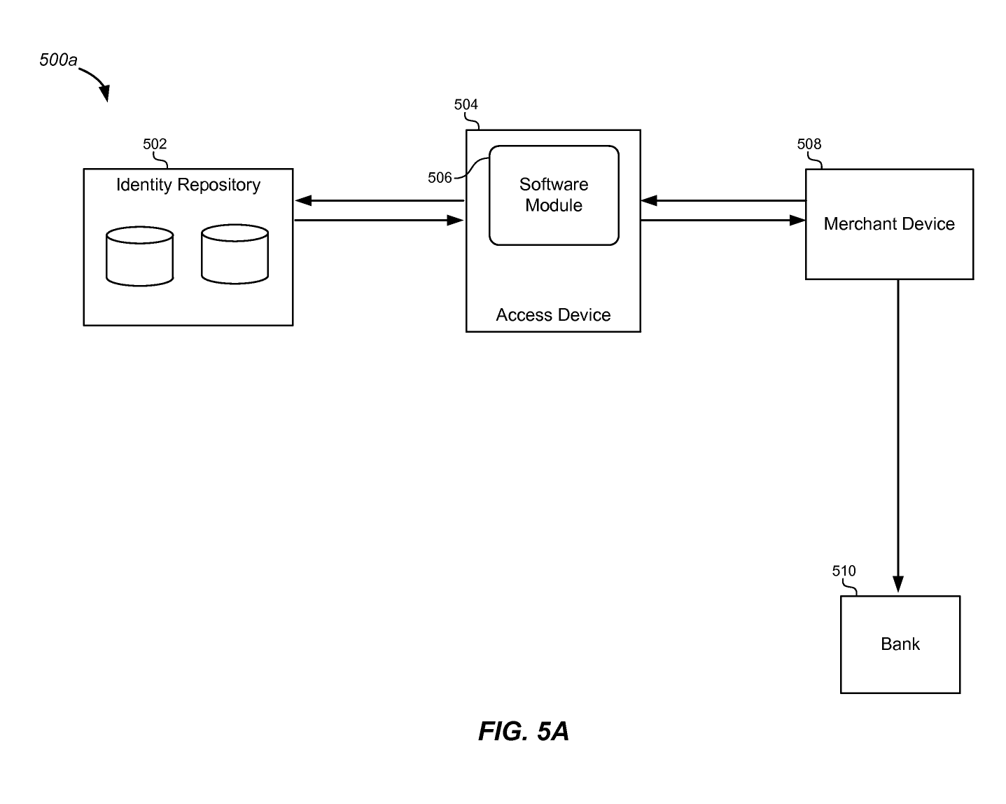

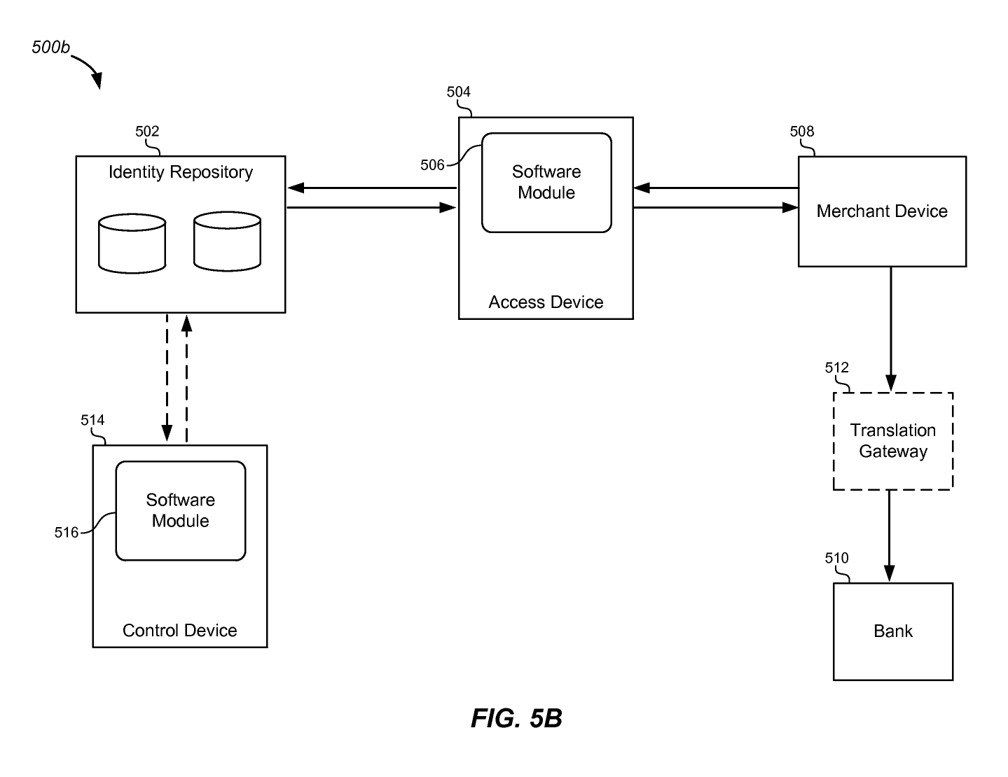

FIG. 5A illustrates a simplified block diagram 500a of devices that may be used to process digital invoices, according to one embodiment. In this simple representation, the merchant device 508 may send a digital invoice to a software module 506 operating on an access device 504 associated with a purchaser. The software module 506 may comprise a web browser, an e-mail client, or in many cases an app made available by an entity associated with the identity repository 502 and available for commercial download. The access device 504 may comprise a smart phone, cell phone, tablet computer, a PDA, a laptop computer, a digital voice recorder, and/or the like. The access device 504 may, in some cases, solicit an authorization for the transaction from the purchaser. The access device 504 may also solicit selections of payment options, such as a preferred payment method.

The access device 504 and/or the identity repository 502 may be used to securely transfer purchasing information to the merchant device 508. Transferring secure purchasing information is described fully in U.S. patent application Ser. No. ______, filed Mar. 12, 2013 (the same date as the present application), entitled “Secure Mobile Transactions” (Attorney Docket No. 94276-868032(000310US)), the entire disclosure of which is incorporated by reference into this application for all purposes.

If the transaction is authorized, the access device 504 may provide a signature for the digital invoice that is associated with the payment type. For example, the user may select their ACME Bank Elite credit card to be used to pay for the transaction. Alternatively, user preferences stored on the access device 504 may automatically select this particular credit card account to pay for the transaction. Once a payment method is selected, the access device 504 may automatically select the proper cryptographic key associated with the payment method and generate a signature for the digital invoice.

In some embodiments, the signature provided by the access device 504 may be sufficient to designate and authorize the payment method. In some embodiments, additional signatures may also be required. The identity repository 502 may provide a second signature for the digital invoice. The access device 504 may send the digital invoice to the identity repository 502. The identity repository may verify the identity of the user of the access device by requiring the user to enter a passcode that can be verified by the identity repository 502. In other cases, the identity repository 502 may operate according to user preferences to verify the identity of the user without requiring a passcode. For example, the identity repository 502 may automatically provide signatures for approved access devices.

In some embodiments, the identity repository 502 may store a record of the digital invoice and the signature provided for future auditing and/or analysis purposes for the purchaser. In some cases, the identity repository 502 may access user preferences to select a payment method. The identity repository 502 may then provide a signature in accordance with the selected payment method. In this case, the access device 504 may wait for the identity repository 502 to return a selected payment method before providing the access device signature. For example, a user may store his preference to use the ACME Bank Elite credit card at the identity repository 502. Upon receiving a digital invoice, the access device 504 could send the digital invoice to the identity repository 502 to receive an indication of the preferred payment method. This may offer the benefit of storing payment options at a secure repository rather than on a user device.

After gaining one or more signatures for the digital invoice, the signatures may be returned to the merchant device 508. In some cases, the digital invoice may also be returned to the merchant device 508. A merchant device 508 may then send the signatures and/or digital invoice to a payment processing device. For example, the signatures and/or digital invoice may be sent to a bank 510. In other embodiments, the signatures and/or digital invoice may be sent to a payment gateway. The payment processing device may use the signatures to determine the preferred payment method, such as a credit card account number, and verify that the transaction is authorized by verifying the signatures. Alternatively, an indication of the preferred payment method may be sent along with the signatures and/or digital invoice and the signatures may be used to verify that the transaction is authorized.

FIG. 5B illustrates a simplified block diagram 500b of additional devices that may be used to process digital invoices, according to one embodiment. Some embodiments may add additional devices to the system for processing digital invoices. In some embodiments, a control device 514 may also be used to provide additional signatures. The identity repository 502 may determine that a level of assurance (LoA) provided by the access device 504, the merchant device 504, and/or the identity repository 502 may require that an out-of-band (OOB) authentication be required to approve the transaction.

The identity repository 502 may send the digital invoice to the control device 514. Alternatively, the identity repository 502 may simply send a request for authorization to the control device 514. A software module 516 operating on the control device 514 may automatically authorize the transaction. Alternatively, the software module 516 may present information descriptive of the transaction to the user of the control device 514. The user may then explicitly authorize the transaction.

The control device 514 may provide an additional signature for the digital invoice. The additional signature may be sent back to the identity repository 502. In some embodiments, the control device 514 may accept a PIN, a password, a passcode, and/or the like, from the user in order to verify the identity of the user. In cases where the control device 514 is used to provide a third signature, the merchant device 508 may receive three signatures from the access device 504.

In some embodiments, a translation gateway 512 may be used to process the signatures and prepare the payment information for a payment processing device. The term translation gateway should be interpreted broadly as a descriptive term to describe any entity or device that may be used to translate, reformat, decrypt, process, and/or route signatures provided by the access device 504, identity repository 502, and/or control device 514 for processing at a payment processing device. For example, the translation gateway 512 may store a set of public keys that correspond to the private keys used to provide the signatures. The translation gateway may verify that the signatures are correct, decrypt payment information provided by the signatures, translate account identifiers into account numbers, repackage payment information into formats that are acceptable by existing payment systems, and so forth.

In addition to the payment processing device, such as a bank 510, and the translation gateway 512, many other devices, networks, routers, and payment systems may be included as part of processing the transaction. For example, a payment gateway may also be included. Different devices and networks associated with credit card companies may also be included. Additionally, specialized banking software systems and devices may also be used in the transaction.

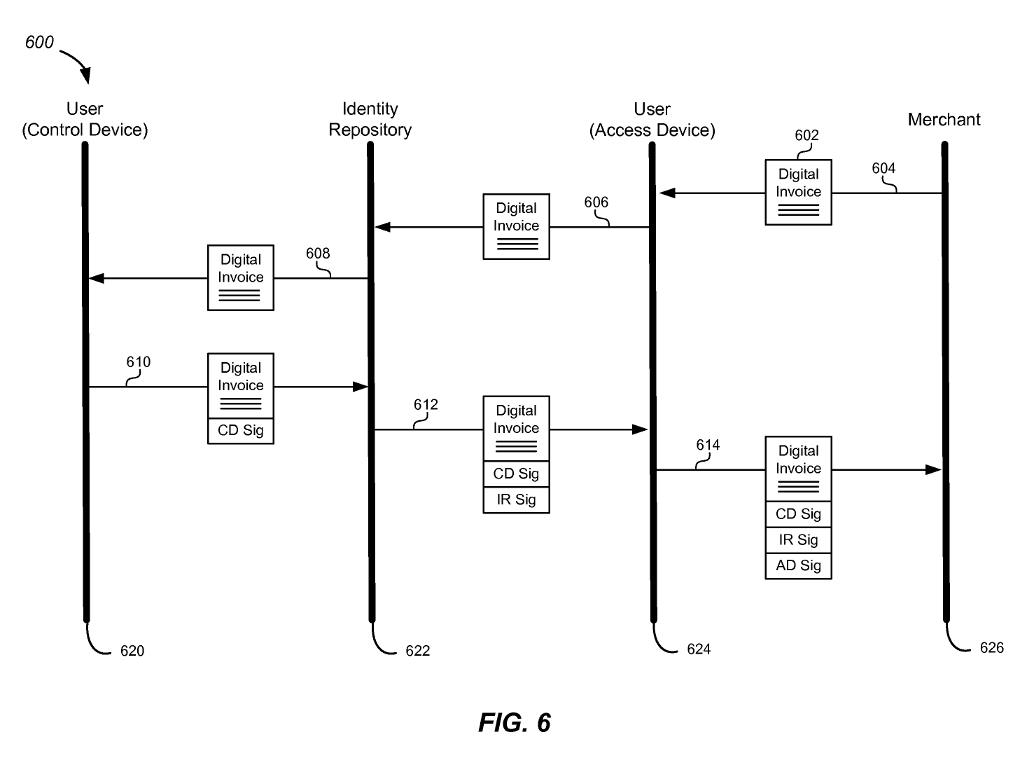

FIG. 6 illustrates a simplified swim diagram 600 of signatures for a digital invoice, according to one embodiment. In this particular embodiment, the digital invoice 602 may be transmitted between each device involved in the transaction. However, in other embodiments, the digital invoice need not be transmitted to each device. For example, the access device 624 may receive the digital invoice and present an authorization request to the identity repository 622 and/or the control device 620 without sending the digital invoice. Additionally, the access device 624 need not send a digital invoice back to the merchant device 626. Different combinations may be used.

In this embodiment, the merchant 626 may send a digital invoice 602 to the access device 624 (604). The digital invoice 602 may also be sent to the identity repository 622 (606) and the control device 620 (608). The control device 620, the identity repository 622, and/or the access device 624 may provide a signature for the digital invoice 602 that is passed back to the merchant 626 (610, 612, 614).

Signatures may be provided in a number of different ways. In one embodiment, the information associated with the digital invoice may be signed using cryptographic keys associated with the selected payment method. For example, a data packet including information from the digital invoice may be encrypted using the cryptographic key associated with the selected payment method. For example, the access device 624 may store a cryptographic key, such as a private key, that is associated with a particular ACME Bank credit card account. The digital invoice may include information such as an amount to be charged, a merchant name, a merchant address, products types, and so forth. A data packet including information from the digital invoice may be encrypted using the cryptographic key. When a translation gateway or payment processing device later receives the encrypted packet, the packet can be decrypted using a corresponding cryptographic key, such as a public key. The information from the digital invoice may then be read, and an appropriate amount may be charged. These embodiments may offer the advantage of encoding the amount to be charged with the signature. This may prevent the merchant 626 or any other party from altering the amount to be charged.

In some embodiments, a nonce may be provided that is associated with the digital invoice. The nonce may be signed (or encrypted) using cryptographic keys at each user device and the identity repository. The signed nonce may be transmitted with the digital invoice, or the nonce may be used to reference a digital invoice that is stored in a location accessible by the translation gateway and/or payment processing device.

In some embodiments, a nonce may be generated by the access device 624, the identity repository 622, and/or the control device 620. The generated nonce may be deterministic and based on transaction details, the time of the transaction, the date of the transaction, the location of the transaction, GPS coordinates of the transaction, and/or the like. In these embodiments, the signed nonce may authorize transactions from the user using the selected payment method within a particular geographic boundary, time interval, price range, and/or the like.

Generally, some embodiments may sign transaction information such that the transaction information being signed cannot be altered before the signatures are verified by the payment processing device or translation gateway. For example, a data packet may be generated that includes the price and merchant ID for the transaction, and the data packet may be encrypted using a cryptographic key associated with the selected payment method. The encrypted data packet can then be returned to the merchant device 626.

In some embodiments, the merchant device 626 may have access to cryptographic information, such as public keys, that can be used to verify the signatures for the digital invoice 602. In other embodiments, the merchant 626 can forward the signatures to a payment processing device and/or a translation gateway, which can then return an indication to the merchant device 626 that the signatures have been verified and that the payment can be completed.

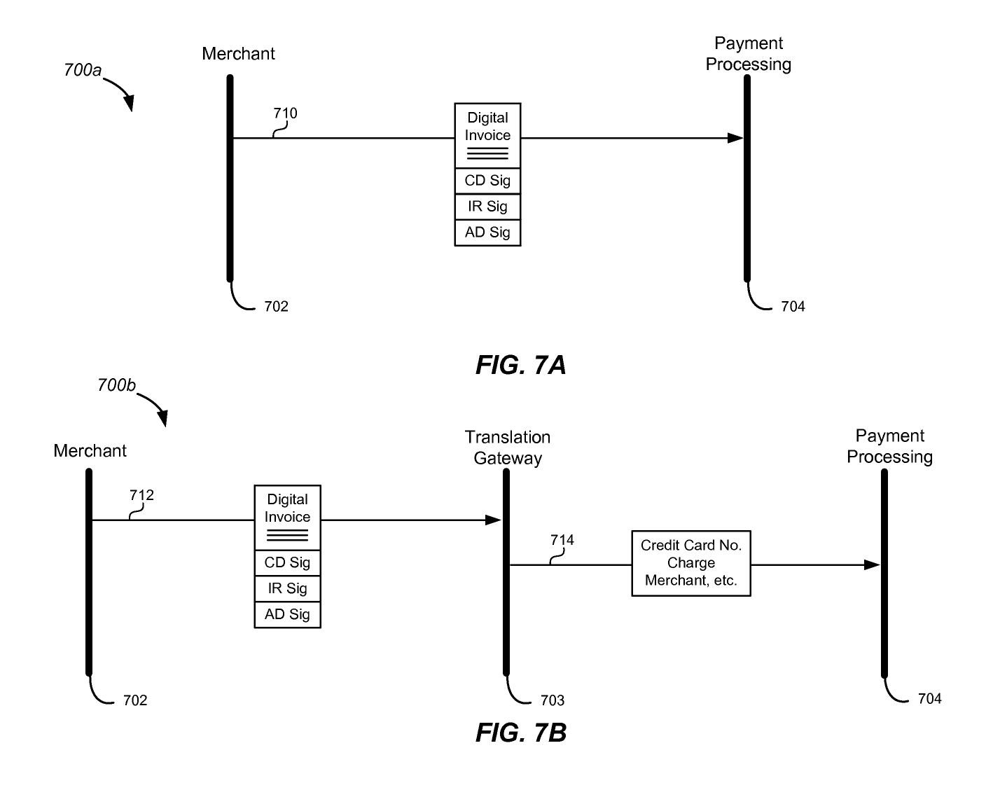

FIG. 7A illustrates a simplified swim diagram 700a of processing a signed digital invoice, according to one embodiment. The merchant 702 may send the signatures provided for the digital invoice to a payment processing device 704 (710). The payment processing device may be any device, system, network, server, and/or the like, that is configured to accept and/or process payment information to settle the transaction. In some embodiments, only the signatures are sent. In some embodiments, the digital invoice may also be included along with other information provided by the merchant 702 or other devices involved in the transaction.

In some embodiments, the data packet sent from the merchant 702 may include some indication of the preferred payment method. For example, the data packet may specify a particular credit card company or banking institution. In some embodiments, the signatures may be specific to a particular payment network, credit card company, credit card, account number, banking institution, and/or the like. In these embodiments, the data packet may include some indication of the type of signature that is being sent. For example, the signatures may be specific to the ACME Bank Elite card, and the data packet may include an indication that the ACME Bank Elite card is the selected payment method.

In some embodiments, the data packet sent from the merchant 702 may also include an identifier designating the purchaser. For example, the data packet may include a first name, last name, a customer ID number, a credit card serial number, and/or the like, that may be used by the payment processing device 704 to access a particular user account.

In some embodiments, the data packet sent from the merchant 702 may include a credit card serial number. Generally, the serial number cannot be used to settle transactions and incur charges against the credit card account. The serial number is merely a means of identifying the card amongst the plurality of cards issued by the banking institution or credit card company. However, the serial number may be used to identify an owner of the card and a particular card type. Using this information, the payment processing device 704 may access a particular user/card account and retrieve cryptographic keys that can be used to verify the signatures when the signatures are specific to that particular card.

In some embodiments, credit card and account information may be encrypted using a user-specific signature or credit-card-company-specific signature. The payment processing device 704 could then decrypt the credit card and account information to determine which card or account is the selected payment method. The payment processing device 704 could then retrieve the associated cryptographic keys that can be used to verify the card-specific signatures that authorize the transaction.

FIG. 7B illustrates a simplified swim diagram 700b of processing a signed digital invoice using a translation gateway, according to one embodiment. In this embodiment, a translation gateway 703 may be inserted to process the signatures provided from the merchant device 702 before payment information is sent to the payment processing device 704. This embodiment may allow existing payment processing networks, payment gateways, banking systems, and/or credit card systems to be compatible with the signature-based methods described herein.

In some embodiments, the translation gateway 703 may receive the data packet including the signatures from the merchant device 702. The translation gateway may then perform the functions that were performed by the payment processing device 704 in relation to FIG. 7A above. The translation gateway 703 may receive the signatures, digital invoice, and/or any other information sent from the merchant device 702, and translate that information to a data packet that can be processed by traditional payment processing devices, such as credit card networks. For example, the translation gateway 703 may decrypt any encrypted portions of the data packet, verify the signatures, extract credit card numbers and payment information, and forward a properly formatted message to the payment processing device 704. The format of the message and the information included therein may depend upon the particular payment processing device associated with the selected payment method. For example, payments to Anthem Bank may require different information and/or formatting than payments to the ACME Bank.

In some embodiments, the translation gateway 703 may be provided by the identity repository that provides signatures for the digital invoices. The identity repository may verify the signatures, prepare a formatted credit card transmission, send the transmission to the payment processing device 704, and send an indication to the merchant device 702 that the transaction has been authenticated and completed. In other embodiments, the translation gateway 703 may be provided by a banking institution, a credit card network, a payment network, and/or any other third party involved in the processing of transaction payments.

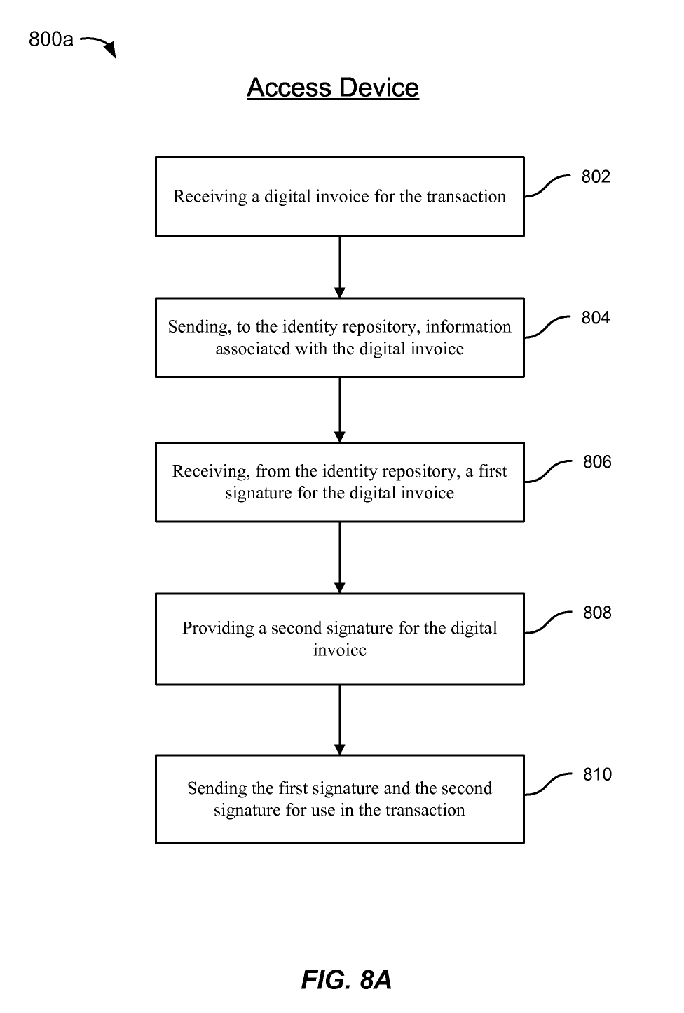

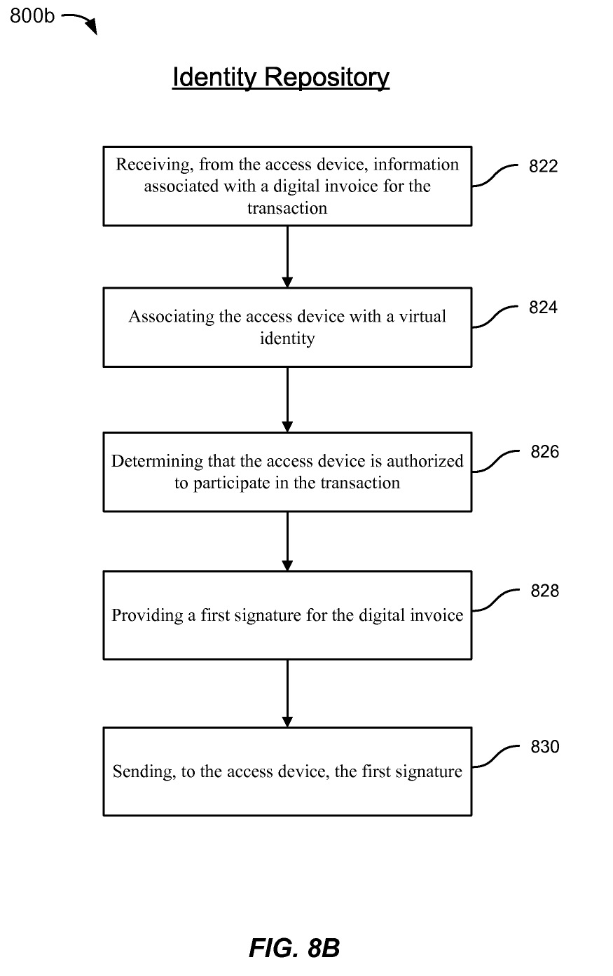

FIG. 8A illustrates a simplified flowchart 800a of a method of securely processing a digital invoice using an access device, according to one embodiment. The steps of this method may be carried out using an access device, such as a smart phone, a tablet computer, a PDA, a laptop computer, and/or the like. The method may include receiving a digital invoice for the transaction (802). The digital invoice may be transmitted from a merchant device. The transmission may be facilitated using Bluetooth technology, 802.11 wireless standard technology, NFC transmissions, radio transmissions, infrared transmissions, e-mail, text message, digital voice recognition, transmissions using a physical media, such as a USB drive, and/or the like. In some embodiments, a paper invoice may be digitally scanned by a computing device, including the access device.

The digital invoice may include information descriptive of the transaction, such as a price, a merchant name, an address, product descriptions, and/or the like. The invoice may include acceptable payment methods. The digital invoice may include specific types of information requested to complete the transaction, such as product options, shipping addresses, billing addresses, payment methods, and/or the like.

The method may additionally include sending, to the identity repository, information associated with the digital invoice (804). In some embodiments, the information associated with the digital invoice may comprise the digital invoice itself. In other words, the access device may send the digital invoice to the identity repository in its entirety. In other embodiments, the information associated with the digital invoice may represent at least a portion of the information communicated by the digital invoice. The information associated with the digital invoice may be reformatted to match encrypted field/value pairs stored at the identity repository.

In some embodiments, the access device may also send additional requests to the identity repository, such as a request to provide a signature for the transaction. The method may further include receiving, from the identity repository, a first signature for the digital invoice (806). The first signature may be associated with a particular payment method. The first signature may also be associated with a particular bank or credit card company. The first signature may also be associated with a particular credit card. The first signature may be generated using a private key for which a corresponding public key may be stored at a payment processing device.

In some embodiments, the access device may also receive a third signature from the identity repository. The third signature for the digital invoice may be provided by a control device. The third signature may also be sent from the access device to the identity repository for use in the transaction. In some embodiments, the control device may comprise the same physical hardware as the access device operating a different software module. For example, the access device may comprise an app operating on a smart phone, while the control device may comprise a browser operating on the same smart phone.

The method may also include providing a second signature for the digital invoice (808). The second signature may be provided by the access device. The access device may request and receive a passcode from a user to verify the identity of the user. The passcode may be encrypted, transformed, salted, shifted, and/or the like and sent to the identity repository for verification. The access device may also request information from the user. For example, the access device may request that the user select a payment method, such as a particular credit card account.

In some embodiments, the first signature and the second signature may be configured to be verified by a payment processing device such that the payment processing device can provide a credit card number to a bank or credit card company. For example, the first signature may comprise a credit card account number encrypted using a cryptographic key associated with the account number, credit card company, or user account. In some embodiments, the first signature may comprise transaction information, such as a price or amount authorized to be charged, that is encrypted using a cryptographic key.

The method may additionally include sending the first signature and the second signature for use in the transaction (810). The first signature and the second signature may be sent to the merchant device, from which they may be forwarded to a payment processing device, a transaction gateway, a payment network, and/or the like. On occasions where a third signature is provided by the control device, the third signature may also be sent to the merchant device. In some embodiments, the signatures may be sent directly to the payment Gateway, translation gateway, payment processing device, etc. from which an indication that the transaction has been approved may be sent to the merchant device.

FIG. 8B illustrates a simplified flowchart 800b of a method of securely processing a digital invoice using an identity repository, according to one embodiment. The steps of this method may be carried out by an identity repository. In some embodiments, the identity repository may comprise a fully encrypted repository storing values in encrypted key/value pairs. In some embodiments, the cryptographic keys that allow access to the encrypted information may be stored at locations away from the encrypted repository, such as at the access device. In some embodiments, the identity repository may be geographically remote from other devices involved in transaction, such as the access device, the merchant device, the payment processing device, and/or the like. The term geographically remote may indicate that the identity repository uses separate physical hardware, is stored in a separate facility, and is separated by a considerable distance from other devices, such as 1 mile, 10 miles, 25 miles, and so forth.

The method may include receiving, from the access device, information associated with a digital invoice for the transaction (822). The information associated with the digital invoice may comprise the digital invoice itself. Alternatively, the information associated with the digital invoice may be transactional information taken from the digital invoice. The access device may also send an explicit request to authorize the transaction.

The method may additionally include associating the access device with a virtual identity (824). In some embodiments, the transmission including the information associated with the digital invoice may also include a global user ID (GUID) that may be used to identify a user account. Each access device associated with the user account may have a unique device ID (DEVID). The term virtual identity may be construed broadly to include any identifying information stored at the identity repository and related to a user account.

The method may further include determining that the access device is authorized to participate in the transaction (826). The identity repository may store user preferences that determine which access devices and/or control devices may be used in particular transaction types. For example, less secure access devices may be restricted to low-dollar-value transactions. In some cases, the identity repository may request that the user enter an identifying passcode into the access device. The passcode may then be salted, shifted, encrypted, or otherwise obscured and transmitted to the identity repository. The identity repository may then use the passcode to verify the identity of the user. An authenticated user identity may also serve to authorize the access device to participate in the transaction.

The method may also include providing a first signature for the digital invoice (828). In some embodiments, the identity repository may sign a packet that includes some of the information associated with the digital invoice. In some embodiments, the identity repository may sign the digital invoice itself. As described above, the signature may be generated using cryptographic keys that are specific to a selected payment method, bank, transaction type, and so forth. In some embodiments, the identity repository may provide an account number, such as a credit card number, to be encrypted as part of the signature. This may provide the advantage of obscuring the account number as it is transmitted between parties involved in the transaction.

The method may additionally include sending, to the access device, the first signature (830). In some cases, the identity repository may also send a request for a second signature to a control device. Thereafter, the identity repository may receive a second signature from the control device for the digital invoice. The signature provided by the control device may also be transmitted to the access device.

It should be appreciated that the specific steps illustrated in FIGS. 8A-8B provide particular methods of securely processing digital invoices according to various embodiments of the present invention. Other sequences of steps may also be performed according to alternative embodiments. For example, alternative embodiments of the present invention may perform the steps outlined above in a different order. Moreover, the individual steps illustrated in FIGS. 8A-8B may include multiple sub-steps that may be performed in various sequences as appropriate to the individual step. Furthermore, additional steps may be added or removed depending on the particular applications. One of ordinary skill in the art would recognize many variations, modifications, and alternatives.

### Exemplary Hardware

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

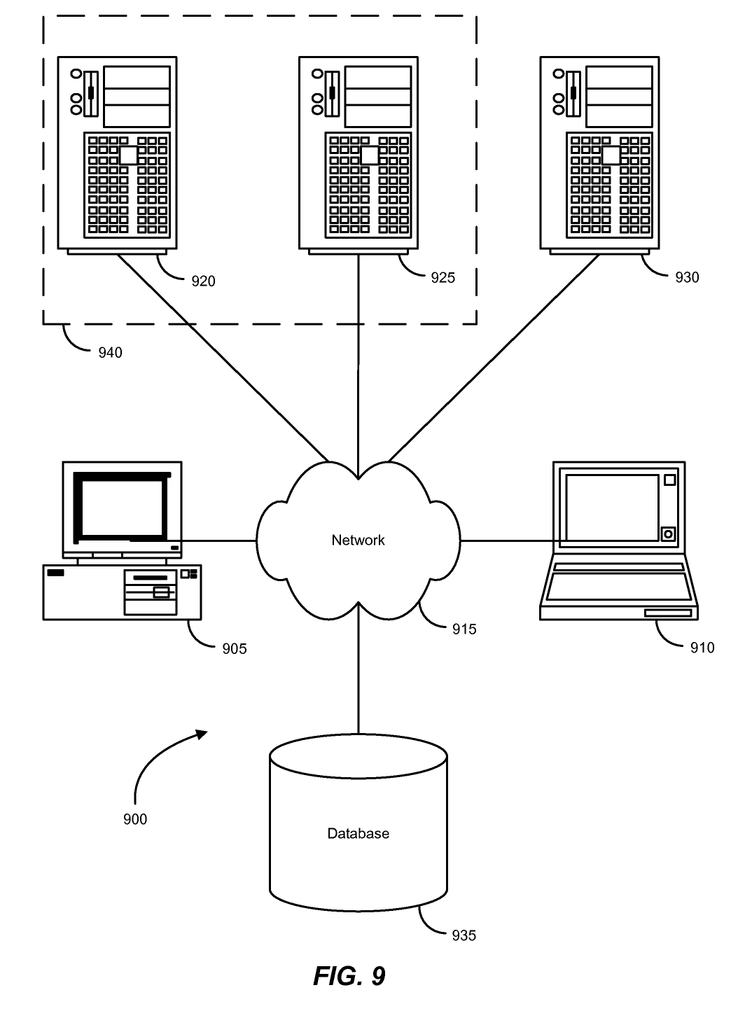

Each of the embodiments disclosed herein may be implemented in one or more computer systems. The computer systems can communicate with each other through a network. FIG. 9 is a block diagram illustrating components of an exemplary operating environment in which various embodiments of the present invention may be implemented. The system 900 can include one or more user computers 905, 910, which may be used to operate a client, whether a dedicated application, web browser, etc. The user computers 905, 910 can be general-purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 905, 910 may also have any of a variety of applications, including one or more development systems, database client and/or server applications, and web browser applications. Alternatively, the user computers 905, 910 may be any other electronic device, such as a thin-client computer, Internet-enabled mobile telephone, and/or personal digital assistant, capable of communicating via a network (e.g., the network 915 described below) and/or displaying and navigating web pages or other types of electronic documents. Although the exemplary system 900 is shown with two user computers, any number of user computers may be supported.

In some embodiments, the system 900 may also include a network 915. The network may can be any type of network familiar to those skilled in the art that can support data communications using any of a variety of commercially-available protocols, including without limitation TCP/IP, SNA, IPX, AppleTalk, and the like. Merely by way of example, the network 915 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 920, 925, 930 which can be general-purpose computers and/or specialized server computers (including, merely by way of example, PC servers, UNIX servers, mid-range servers, mainframe computers rack-mounted servers, etc.). One or more of the servers (e.g., 930) may be dedicated to running applications, such as a business application, a web server, application server, etc. Such servers may be used to process requests from user computers 905, 910. The applications can also include any number of applications for controlling access to resources of the servers 920, 925, 930.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 905, 910. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 905, 910.

In some embodiments, an application server may create web pages dynamically for displaying on an end-user (client) system. The web pages created by the web application server may be forwarded to a user computer 905 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 900 may also include one or more databases 935. The database(s) 935 may reside in a variety of locations. By way of example, a database 935 may reside on a storage medium local to (and/or resident in) one or more of the computers 905, 910, 915, 925, 930. Alternatively, it may be remote from any or all of the computers 905, 910, 915, 925, 930, and/or in communication (e.g., via the network 920) with one or more of these. In a particular set of embodiments, the database 935 may reside in a storage-area network (“SAN”) familiar to those skilled in the art. Similarly, any necessary files for performing the functions attributed to the computers 905, 910, 915, 925, 930 may be stored locally on the respective computer and/or remotely, as appropriate. In one set of embodiments, the database 935 may be a relational database, such as Oracle 10g, that is adapted to store, update, and retrieve data in response to SQL-formatted commands.

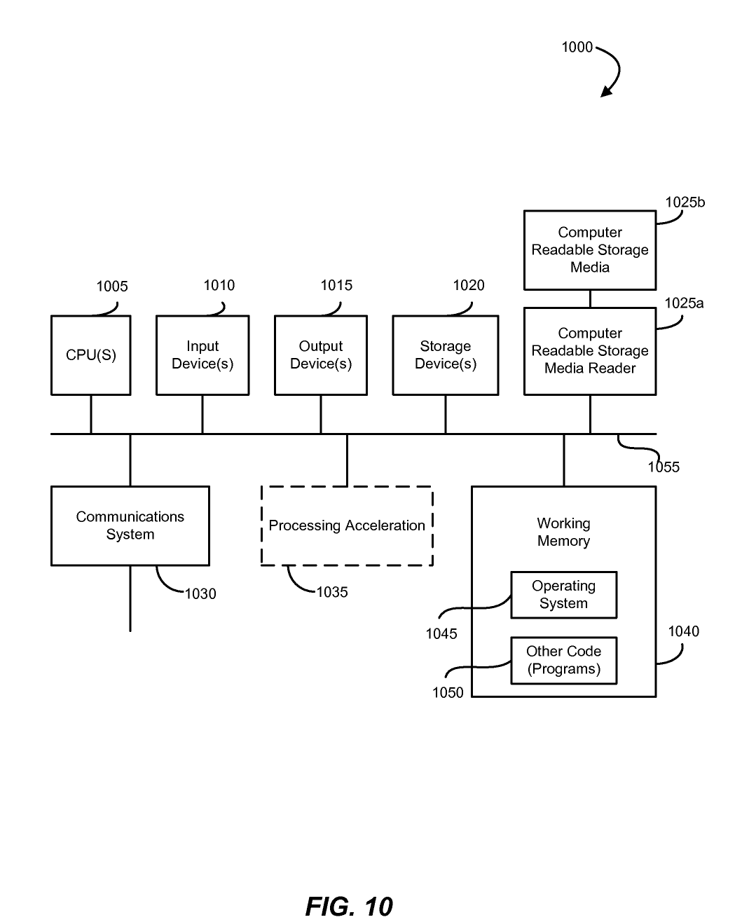

FIG. 10 illustrates an exemplary computer system 1000, in which various embodiments of the present invention may be implemented. The system 1000 may be used to implement any of the computer systems described above. The computer system 1000 is shown comprising hardware elements that may be electrically coupled via a bus 1055. The hardware elements may include one or more central processing units (CPUs) 1005, one or more input devices 1010 (e.g., a mouse, a keyboard, etc.), and one or more output devices 1015 (e.g., a display device, a printer, etc.). The computer system 1000 may also include one or more storage device 1020. By way of example, storage device(s) 1020 may be disk drives, optical storage devices, solid-state storage device such as a random access memory (“RAM”) and/or a read-only memory (“ROM”), which can be programmable, flash-updateable and/or the like.

The computer system 1000 may additionally include a computer-readable storage media reader 1025a, a communications system 1030 (e.g., a modem, a network card (wireless or wired), an infra-red communication device, etc.), and working memory 1040, which may include RAM and ROM devices as described above. In some embodiments, the computer system 1000 may also include a processing acceleration unit 1035, which can include a DSP, a special-purpose processor and/or the like.

The computer-readable storage media reader 1025a can further be connected to a computer-readable storage medium 1025b, together (and, optionally, in combination with storage device(s) 1020) comprehensively representing remote, local, fixed, and/or removable storage devices plus storage media for temporarily and/or more permanently containing computer-readable information. The communications system 1030 may permit data to be exchanged with the network 1020 and/or any other computer described above with respect to the system 1000.

The computer system 1000 may also comprise software elements, shown as being currently located within a working memory 1040, including an operating system 1045 and/or other code 1050, such as an application program (which may be a client application, web browser, mid-tier application, RDBMS, etc.). It should be appreciated that alternate embodiments of a computer system 1000 may have numerous variations from that described above. For example, customized hardware might also be used and/or particular elements might be implemented in hardware, software (including portable software, such as applets), or both. Further, connection to other computing devices such as network input/output devices may be employed. Software of computer system 1000 may include code 1050 for implementing embodiments of the present invention as described herein.

The following methods may be implemented by a computer system, such as computer system 1000 in FIG. 10. Each step of these methods may be done automatically by the computer system, and/or may be provided as inputs and/or outputs to a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Therefore, it will be understood in light of this disclosure, that each step and each method described herein may be altered to include an input and output to and from a user, or may be done automatically by a computer system.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A method of processing a digital invoice using an access device for a transaction between the access device and a merchant device, the method comprising:
receiving, at the access device, a digital invoice for the transaction;
sending, from the access device to an identity repository, information associated with the digital invoice;
receiving, from the identity repository, a first signature for the digital invoice;
providing, by the access device, a second signature for the digital invoice; and
sending, from the access device, the first signature and the second signature for use in the transaction.

2. The method of claim 1 wherein the digital invoice comprises a transaction price.

3. The method of claim 1 wherein the first signature is associated with a particular payment method.

4. The method of claim 3 wherein the first signature and the second signature are associated with a particular bank or credit card company.

5. The method of claim 1 wherein the first signature and the second signature are associated with corresponding cryptographic keys stored at a payment processing device.

6. The method of claim 1 wherein:
the first signature is generated using a private key; and
a public key corresponding to the private key is stored by a payment processing device.

7. The method of claim 1 further comprising receiving, by the access device, an input comprising a selection of a payment method.

8. The method of claim 1 further comprising:
receiving, from the identity repository, a third signature for the digital invoice, wherein the third signature is provided by a control device; and
sending, from the access device, the third signature for use in the transaction.

9. The method of claim 1 wherein the first and second signatures are configured to be verified by a payment processing device such that the payment processing device can provide a credit card number.

10. The method of claim 1 further comprising:
providing, by the access device, an output comprising a request for a passcode to verify an identity of a user;
receiving, by the access device, an input comprising the passcode; and
sending, from the access device to the identity repository, the information associated with the passcode for the identity repository to verify the identity of the user.

11. The method of claim 1 further comprising:
providing, by the access device, a first identifier that identifies a payment provider;
providing, by the access device, a second identifier that identifies an account at the payment provider; and
sending, from the access device, the first identifier and the second identifier with the first signature and the second signature, wherein:
the first digital signature and the second digital signature are generated using private keys;
the private keys are associated with public keys at the payment provider; and
the public keys are associated with the account or a user of the access device at the payment provider.

12. A method of processing a digital invoice for a transaction between an access device and a merchant device by an identity repository, the method comprising:
receiving, at the identity repository from the access device, information associated with a digital invoice for the transaction;
associating the access device with a virtual identity;
determining that the access device is authorized to participate in the transaction;
providing, by the identity repository, a first signature for the digital invoice; and
sending, from the identity repository to the access device, the first signature.

13. The method of claim 12 wherein the first signature is associated with a selected payment method.

14. The method of claim 12 wherein the first signature is generated by encrypting at least part of the information associated with the digital invoice using a cryptographic key.

15. The method of claim 12 further comprising pre-registering a public key to be stored by a payment processing device, wherein the public corresponds to a private key associated with the virtual identity.

16. The method of claim 12 further comprising:
receiving a selection of a payment method;
retrieving an account identifier associated with the payment method from the virtual identity; and
encrypting the account number to generate the first signature.

17. The method of claim 12 further comprising:
sending, from the identity repository to a control device, request for a second signature; and
receiving, by the identity repository from the control device, a second signature for the digital invoice.

18. An identity repository for providing secure information for a transaction between an access device and a relying party device, the identity repository comprising:
one or more processors; and
a memory communicatively coupled with and readable by the one or more processors and comprising a sequence of instructions which, when executed by the one or more processors, cause the one or more processors to facilitate the transaction by:
receiving, at the identity repository, information associated with a digital invoice for the transaction;
associating the access device with a virtual identity;
determining that the access device is authorized to participate in the transaction;
providing, by the identity repository, a first signature for the digital invoice; and
sending, from the identity repository to the access device, the first signature, wherein the access device provides a second signature for the digital invoice.

19. The identity repository of claim 18 wherein the identity repository is geographically remote from the access device.

20. The identity repository of claim 18 further comprising a fully encrypted repository storing encrypted field/value pairs, wherein:
an account identifier is stored as an encrypted value; and
the account number is associated with a selected payment method.
